(19) United States
(12) Patent Application Publication
(10) Pub. No.: US 2006/0015334 A1
(43) Pub. Date: Jan. 19, 2006

(54) Method to process two audio input signals

(75) Inventor: Ljubomir Milanovic, Vienna (AT)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/523,941

(22) PCT Filed: Aug. 5, 2003
(86) PCT No.: PCT/IB03/03448

§ 371 Date: Feb. 8, 2005

(30) Foreign Application Priority Data
Aug. 12, 2002 (EP) 02102122.5

(51) Int. Cl. G10L 15/26; H04N 11/00

(52) U.S. Cl. 704/235; 348/468

(57) ABSTRACT

In order to provide a method and a device for the processing of at least two input signals (Si) which contain audio (Ai) and possibly also video information (Vi) which enable the reproduction of the text information (T2) of at least one further input signal (S2) in addition to the reproduction of an input signal (S1), there is provided a reproduction device (10) for the reproduction of an input signal (S1), and also speech recognition means (11) for determining text information (T) contained in the audio information (A2) of at least one second input signal (S2), and also an optical reproduction device (12) for the reproduction of the text information (T2) determined. The reproduction devices (10, 12) may be formed, for example, by a common monitor (13).

The invention relates to a method for the processing of at least two input signals which contain audio information and possibly also video information, in which method the audio information and possibly also video information of a first input signal is processed for acoustic and possibly also audiovisual reproduction.

The invention also relates to a device for the processing of at least two input signals which contain audio information and possibly also video information, which device comprises a reproduction device for the reproduction of a first input signal.

It is known to provide television signals with text, in addition to the audio and video information of a television program, which text contains, for example, headlines, stock exchange data or other current information. It is also known to reproduce a second television signal optically in a small section of the display screen. The audio signal of this further television signal in the so-called PIP (picture-in-picture) method is not reproduced. Also known are inserted texts which optically reproduce the audio signal of the reproduced television signal at least partly for the benefit of persons who are deaf or hard of hearing.

U.S. Pat. No. 5,557,338 A discloses a television system in which the picture comprises a main picture and a secondary picture and in which additionally text information in the form of a subtitle is reproduced in the main picture, which text information relates to the broadcast reproduced in the secondary image. The transmitter then has to transmit the text information together with the information of the secondary picture. This system constitutes an extension of the so-called PIP (picture-in-picture) method in which text information is reproduced in addition to the secondary picture.

It is an object of the present invention to provide a method and a device of the kind set forth whereby at least one further input signal can be reproduced in addition to a reproduced input signal. The reception of at least one further acoustic or audiovisual input signal is thus made possible wherever an acoustic or audiovisual input signal is already received. It should be possible to use the method also in locations where acoustic reception of an input signal is not possible, for example, because of excessive ambient noise.

In respect of the method the object in accordance with the invention is achieved by means of a method for the processing of at least two input signals which contain audio information and possibly also video information, in which method the audio information and possibly also the video information of the one input signal is processed for acoustic and possibly also audiovisual reproduction, at least one second input signal is applied to speech recognition means, text information concerning the audio information contained in at least the second input signal is determined by means of the speech recognition means, and the text information determined is optically reproduced.

The method in accordance with the invention thus enables different input signals to be processed in such a manner that the speech occurring therein is recognized and converted into text which is optically reproduced. This enables, for example, the text of a different television broadcast to be inserted in the picture during the reception of a television broadcast. The user can thus be informed about other topics during the reception of a television broadcast. The input signal whose speech is recognized may then also originate from a different external source, for example, from a radio receiver, a video recorder or also from a telephone line. The information received in the form of an audio signal from a radio station can thus be reproduced as text during the reproduction of a television broadcast. It is also possible to optically reproduce incoming telephone calls which are routed to a telephone answering machine, so that the user can obtain information concerning the call and, for example, decide whether or not to accept the call. The speech recognition makes it possible to process practically any input signal containing audio information and possibly also video information and to reproduce such an input signal in addition to a first input signal.

The object in accordance with the invention is also achieved by means of a device for the processing of at least two input signals which contain audio information and possibly also video information, which device comprises a reproduction device for the reproduction of an input signal, speech recognition means for determining text information contained in the audio information of at least one second input signal, and an optical reproduction device for the reproduction of the text information determined.

The speech recognition means may be separate from the reproduction device of the one input signal and the optical reproduction device for the reproduction of the text information determined, or be integrated in one of said devices. It is also possible for all components of the device in accordance with the invention to be integrated in one apparatus, for example, in a television receiver. The external or integrated speech recognition means enable the processing of the audio information of at least one second input signal and to optically reproduce the text information determined therefrom in addition to a first input signal.

The text information is advantageously reproduced as a running text, the speed of the running text being automatically adapted to the reproduction. It is also possible to buffer the text information and to reproduce it in a delayed fashion. For example, a radio broadcast could be processed at predetermined instants by means of speech recognition means, and the text information determined, for example, the headlines, could be buffered and be optically reproduced at predetermined instants, or at instants selected by the user, during the reproduction of an input signal.

The video information of the one input signal and the text information of the at least one further input signal are advantageously reproduced on a common monitor. If the first input signal reproduced is not a video signal, the text information of the at least one further input signal can be reproduced on a suitable display which is provided especially for this purpose or which is already present. For example, the first input signal may be the acoustic signal of a telephone and a second incoming telephone call can be optically reproduced on the display of the telephone.

The second input signal can advantageously be selected by the user. The user can thus decide which text information is additionally reproduced in an optical fashion during the reproduction of an input signal.

The selection of the second input signal can then be performed on the basis of stored information. This information may involve given criteria as selected by the user or may also concern automatically detected user habits.

Parameters of the speech recognition means are advantageously modified on the basis of the text information of the second input signal. As a result, for example, the speech recognition means can be optimally adapted to the second input signal in that, for example, appropriate libraries or languages adapted to the second input signal are selected by recognition of given texts.

It is also advantageous when the text information determined is compared with stored texts and given steps are taken when given comparison results are obtained. For example, the optical reproduction of the text information can be rendered dependent on the correspondence with stored texts. As a result of this feature, it is possible to insert the text only subject to given conditions. In this respect, for example, given keywords can be used as a criterion.

Additionally it may be arranged that in the case of correspondence between the text information and given stored texts the audio information and possibly also video information of the second input signal is reproduced instead of the audio information and possibly also video information of the first input signal. For example, the at least one further input signal can thus be monitored so that automatic switching over to this input signal can take place, for example, at the beginning of a news broadcast or at the beginning of a sports broadcast.

The input signals to be reproduced are advantageously television signals. However, various other input signals, for example, radio signals, telephone signals or the like, are also feasible.

The reproduction device for the reproduction of an input signal and the reproduction device for the reproduction of the text information determined are advantageously formed by a common monitor.

When storage means are provided for the storage of the text information determined, the text information contained in the audio information of at least one further input signal can be stored for later or repeated reproduction.

In order to enable the user to choose from among a plurality of input signals available, in conformity with a further feature of the invention there are provided control means. Such control means may be connected to a memory for information, so that the selection of the at least one second input signal can take place on the basis of the information stored in the memory.

When a switching device is provided for switching over parameters of the speech recognition means, optimum adaptation of the speech recognition means can be achieved on the basis of the text information of the second input signal. For example, upon recognition of the language of the second input signal, the speech recognition means can be adapted to this language and the relevant libraries can be activated.

Advantageously there is provided a comparison unit for comparing the text information with stored texts. This offers a series of further options, for example, text-dependent reproduction of the text information or the like.

In order to enable text-specific reproduction of the text information of a second input signal, said comparison unit may be connected to the optical reproduction unit.

Furthermore, there may be provided a switching unit for switching over the reproduction of the input signals; such a switching unit is connected to the comparison unit. The switching unit may then be formed by said control means for the selection of the input signals.

The reproduction device for the reproduction of an input signal may be formed by a television receiver.

Embodiments of the invention will be described in detail hereinafter with reference to the drawings, however, without the invention being restricted thereto in any way.

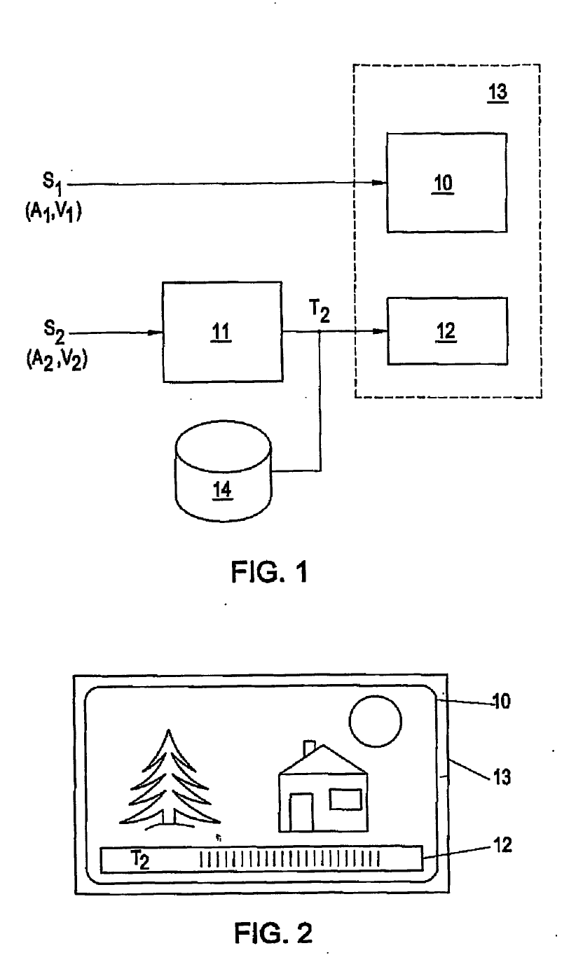

FIG. 1 shows a block diagram of an embodiment of the device for the processing of at least two input signals which contain audio information and possibly also video information.

FIG. 2 shows an example of the reproduction devices for the input signal and the text information determined.

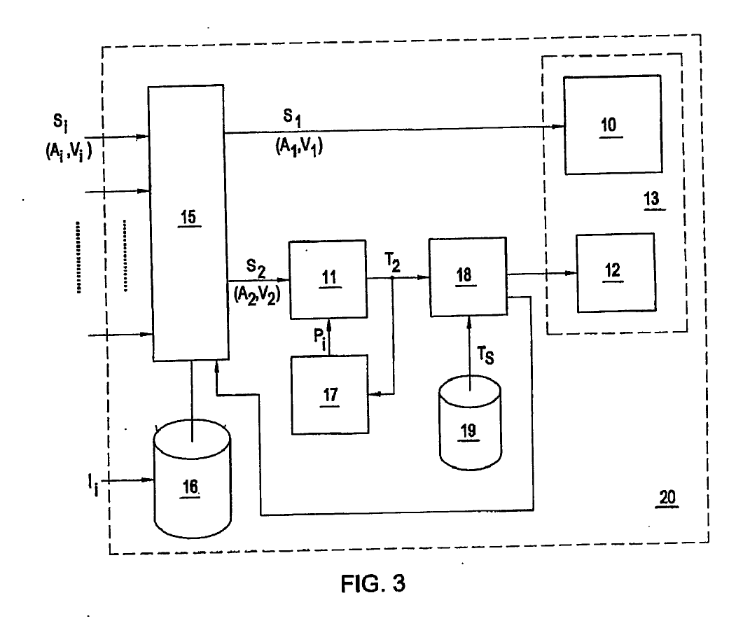

FIG. 3 shows an extended block diagram of a device in accordance with the invention.

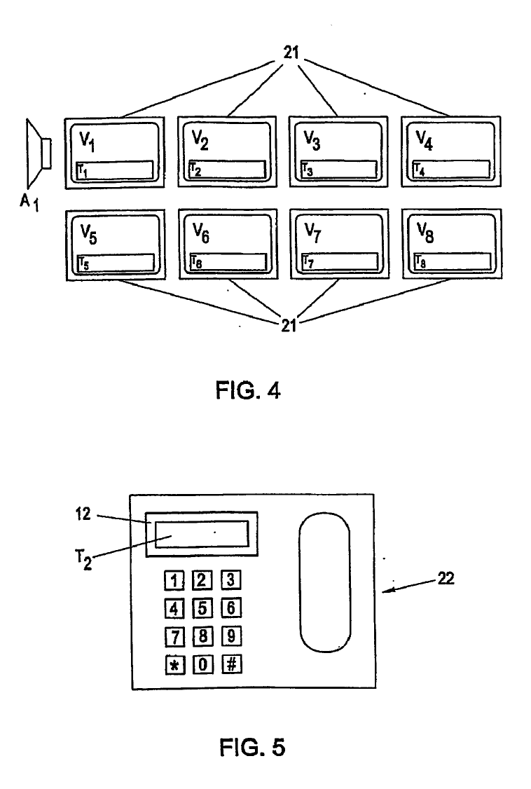

FIG. 4 shows an example of an application in the form of a master control room.

FIG. 5 shows a further application concerning a telephone set.

FIG. 1 shows a block diagram of a device for the processing of at least two input signals Sᵢ which contain audio information Aᵢ and possibly also video information Vᵢ. The device shown serves to process two input signals S₁, S₂, but can be extended at will to an arbitrary number of input signals Sᵢ. The device includes a reproduction device 10 for the reproduction of an input signal S₁, for example, a television receiver, which processes and reproduces the audio information A₁ and possibly also video information V₁ of the input signal S₁. The at least one second input signal S₂ is applied to speech recognition means 11 in which the text information T₂ which is contained in the audio information A₂ of the input signal S₂ is determined. This text information T₂ is reproduced by means of an optical reproduction device 12. It is thus possible to reproduce, in addition to the input signal S₁, also the text information T₂ contained in a further input signal S₂, that is, simultaneously or shifted in time. In order to enable time-shifted reproduction there may be provided storage means 14 for the storage of the text information T₂ determined. Depending on the type of input signal S₁, S₂, it may be advantageous to integrate the reproduction device 10 for the reproduction of the input signal S₁ and the reproduction device 12 for the reproduction of the text information T₂ determined in a common monitor 13 or the like.

FIG. 2 shows an example of such a common monitor 13 which comprises the reproduction device 10 for the reproduction of the first input signal S₁, for example, a television broadcast, and also the optical reproduction device 12 for the text information T₂ determined. The text information T₂ is thus inserted in the form of subtitles in the television picture of the input signal S₁.

FIG. 3 shows a block diagram of a device for the processing of a plurality of input signals S₁ which has been extended in comparison with that shown in FIG. 1. A plurality of input signals Sᵢ which contain audio information Aᵢ and possibly also video information Vᵢ is applied to control means 15 which serve for the selection of the input signals Sᵢ. A first input signal S₁ is then suitably processed and reproduced on a reproduction device 10. At least one further input signal S₂ is applied to the speech recognition means 11 and the text information T₂ which is contained in the audio information A₂ of the input signal S₂ is determined therefrom. The text information T₂ may be applied to a switching device 17 for switching over parameters Pᵢ of the speech recognition means 11, thus enabling optimum adaptation of the speech recognition means 11 to the processed text information T₂. In addition, the text information T₂ can be applied to a comparison unit 18 prior to the optical reproduction, the text information T₂ then being compared with texts T_{S} which are stored in a memory 19 in said comparison unit. As a result of this comparison in the comparison unit 18, for example, text-specific reproduction of the text information T₂ can take place on the optical reproduction device 12. Moreover, the comparison unit 18 may be connected to the control means 15 or to a further switching unit (not shown) so that when a given stored text T_{S} is recognized in the text information T₂, switching over to a different input signal Sᵢ may take place. A memory 16 can serve for the storage of information Iᵢ which may concern, for example, given user habits. The memory 16 is advantageously connected to the control means 15 so that selection of the input signals Sᵢ can be carried out on the basis of the information Iᵢ stored in the memory 16. The reproduction device 10 for the reproduction of an input signal S₁ and the optical reproduction device 12 for the reproduction of the text information T₂ determined can be integrated in a common monitor 13. Moreover, all of the devices in accordance with the invention may be integrated in one apparatus, for example, a television receiver 20.

FIG. 4 shows an application of the invention for a master control room in which, by way of example, a plurality of monitors 21 is provided for the reproduction of video information V₁ to V₈ and audio signals A₁ to A₈ of eight input signals S₁ to S₈. Each time only one audio signal Aᵢ can be received. The other audio signals Aᵢ of the input signals Sᵢ or audio signals from other sources, for example, the audio signals from the camera men or the associated sound technicians, can be displayed on the monitors 21 in the form of text information T₁ to T₈, thus providing the director with further information for the selection of the signal Sᵢ to be broadcast.

FIG. 5 shows a further application of the invention in a telephone set 22, in which, during the reception of a telephone call, the text information T₂ of a further telephone call can be displayed additionally on an optical display device 12 in the form of a display customarily provided in telephone sets. The invention thus offers the user of the telephone set 22 the simultaneous reception of a further telephone call which is diverted, for example, to a telephone answering apparatus. For example, the user can then decide to interrupt the first telephone call and switch over to the second telephone call.

The present invention is by no means restricted to the described examples and can also be applied to various other input signals.

1. A method for the processing of at least two input signals (Sᵢ) which contain audio information (Aᵢ) and possibly also video information (Vᵢ), in which method the audio information (A1) and possibly also video information (V₁) of a first input signal (S₁) is processed for acoustic and possibly also audiovisual reproduction, at least one second input S signal (S₂) is applied to speech recognition means (11), text information (T₂) concerning the audio information (A₂) contained in at least the second input signal (S₂) is determined by means of the speech recognition means (11), and the text information (T₂) determined is optically reproduced.

2. A method as claimed in claim 1, in which the text information (T₂) is reproduced as a running text.

3. A method as claimed in claim 1, in which the text information (T₂) is buffered and reproduced in a delayed fashion.

4. A method as claimed in claim 1, in which the video information (V₁) of the one input signal (S₁) and the text information (T₂) are reproduced on a common monitor (13).

5. A method as claimed in claim 1, in which the second input signal (S₂) is selected.

6. A method as claimed in claim 5, in which the second input signal (S₂) is selected on the basis of stored information (12).

7. A method as claimed in claim 1, in which parameters of the speech recognition means (11) are modified on the basis of the text information (T₂) of the second input signal (S₂).

8. A method as claimed in claim 1, in which the text information (T₂) is compared with stored texts (T_{S}).

9. A method as claimed in claim 8, in which the text information (T₂) is reproduced if it corresponds to stored texts (T_{S}).

10. A method as claimed in claim 8, in which in the case of correspondence between the text information (T₂) and stored texts (T_{S}) the audio information (A₂) and possibly also video information (V₂) of the second input signal (S₂) is reproduced instead of the audio information (A₁) and possibly also video information (V₁) of the first input signal (S₁).

11. A method as claimed in claim 1, in which the input signals (S₁, S₂) are television signals.

12. A device for the processing of at least two input signals (Sᵢ) which contain audio information (Aᵢ) and possibly also video information (Vᵢ), which device includes a reproduction device (10) for the reproduction of a first input signal (S₁), speech recognition means (11) for determining text information (T₂) contained in the audio information (A₂) of at least one second input signal (S₂), and an optical reproduction device (12) for the reproduction of the text information (T₂) determined.

13. A device as claimed in claim 12, in which the reproduction device (10) for the reproduction of an input signal (S₁) and the reproduction device (12) for the reproduction of the text information (T₂) determined are formed by a common monitor (13).

14. A device as claimed in claim 12, in which storage means (14) are provided for the storage of the text information (T₂) determined.

15. A device as claimed in claim 12, in which control means (15) are provided for the selection of the input signals (Sᵢ).

16. A device as claimed in claim 15, in which a memory (16) is provided for information (Iᵢ), which memory (16) is connected to the control means (15) in such a manner that the input signals (Sᵢ) are selected on the basis of the information (Iᵢ) stored in the memory (16).

17. A device as claimed in claim 12, in which there is provided a switching device (17) for switching over parameters (Pᵢ) of the speech recognition means (11) on the basis of the text information (T₂) of the second input signal (S₂).

18. A device as claimed in claim 12, in which there is provided a comparison unit (18) for comparing the text information (T₂) with stored texts (T_{S}).

19. A device as claimed in claim 18, in which the comparison unit (18) is connected to the optical reproduction unit (12).

20. A device as claimed in claim 18, in which there is provided a switching unit for switching over the reproduction of the input signals (S₁, S₂), which switching unit is connected to the comparison unit (18).

21. A device as claimed in claim 12, in which the reproduction unit (10) for the reproduction of an input signal (S₁) is formed by a television receiver (20).
